(19) United States
(12) Patent Application Publication
(10) Pub. No.: US 2026/0220246 A1
(43) Pub. Date: Jul. 30, 2026

(54) DEBUG RE-ENABLEMENT USING HASH CHAIN-BASED MESSAGE AUTHENTICATION

(71) Applicant: QUALCOMM Incorporated, San Diego, CA (US)

(72) Inventors: Joona Verneri KANNISTO, Salo (FI); Tarik ISANI, San Jose, CA (US)

(21) Appl. No.: 19/036,862

(22) Filed: Jan. 24, 2025

(51) Int. Cl. G06F 21/44

(52) U.S. Cl. CPC G06F 21/44; G06F 2221/2103

(57) ABSTRACT

Systems and techniques are provided for processor debugging. For instance, a process can include transmitting a challenge message, the challenge message including a public value of a device and a current replay counter value of the device; receiving, in response to the challenge message, an intermediate hash value; hashing the intermediate hash value a first number of times to obtain a candidate hash value, wherein the first number of times is based on the current replay counter value; comparing the candidate hash value to the public value; and enabling debugging based on the compared candidate hash value to the public value.

### FIELD

The present application is related to processor debugging. For example, aspects of the present application relate to systems and techniques for debug re-enablement using hash chain-based message authentication, for example for a system-on-a-chip (SoC).

### BACKGROUND

After a chip, such as a SoC, processor, or other component may encounter an issue. To resolve this issue, debugging may be performed on the chip to determine what may have caused the issue. To assist in debugging a chip may include a debugging mode or state may be accessed. As these debugging features may allow some protections built into the chip to be circumvented, confidential information to be accessed, or otherwise allow the chip to operate in ways that are not permitted in normal use (e.g., in a normal or user mode), access to debugging features may be secured. As an example, access to debugging features may be secured using digital signatures or embedded symmetric keys. However, implementing digital signature verification in hardware can be very expensive for relatively low powered chips and embedded symmetric keys may present security concerns. Thus, improved techniques for debug re-enablement may be useful.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems and techniques for debug re-enablement using hash chain-based message authentication. In one illustrative example, an apparatus for digital asset distribution is provided. The apparatus includes at least one memory and at least one processor coupled to the at least one memory. The at least one processor is configured to: transmit a challenge message, the challenge message including a public value of the apparatus and a current replay counter value of the apparatus; receive, in response to the challenge message, an intermediate hash value; hash the intermediate hash value a first number of times to obtain a candidate hash value, wherein the first number of times is based on the current replay counter value; compare the candidate hash value to the public value; and enable debugging based on the compared candidate hash value to the public value.

In another example, a method for debugging is provided. The method includes: transmitting a challenge message, the challenge message including a public value of a device and a current replay counter value of the device; receiving, in response to the challenge message, an intermediate hash value; hashing the intermediate hash value a first number of times to obtain a candidate hash value, wherein the first number of times is based on the current replay counter value; comparing the candidate hash value to the public value; and enabling debugging based on the compared candidate hash value to the public value.

As another example, a non-transitory computer-readable medium having stored thereon instructions is provided. The instructions, when executed by at least one processor, cause the at least one processor to: transmit a challenge message, the challenge message including a public value of the apparatus and a current replay counter value of the apparatus; receive, in response to the challenge message, an intermediate hash value; hash the intermediate hash value a first number of times to obtain a candidate hash value, wherein the first number of times is based on the current replay counter value; compare the candidate hash value to the public value; and enable debugging based on the compared candidate hash value to the public value.

In another example, an apparatus for debugging is provided. The apparatus includes: means for transmitting a challenge message, the challenge message including a public value of a device and a current replay counter value of the device; means for receiving, in response to the challenge message, an intermediate hash value; means for hashing the intermediate hash value a first number of times to obtain a candidate hash value, wherein the first number of times is based on the current replay counter value; means for comparing the candidate hash value to the public value; and means for enabling debugging based on the compared candidate hash value to the public value.

As another example, an apparatus for debugging is provided. The apparatus includes: at least one memory; and at least one processor coupled to the at least one memory, the at least one processor being configured to: receive a challenge message in response to a request to enable debugging from a target device, wherein the challenge message includes a public value of the target device, and a current replay counter value of the target device; hash a secret value a first number of times to obtain an intermediate hash value, wherein the first number of times is based on the current replay counter value and a maximum value of a replay counter; and transmit, in response to the challenge message, a challenge response including the intermediate hash value.

In another example, a method for debugging is provided. The method includes: transmitting a challenge message, the challenge message including a public value of a device and a current replay counter value of the device; receiving, in response to the challenge message, an intermediate hash value; hashing the intermediate hash value a first number of times to obtain a candidate hash value, wherein the first number of times is based on the current replay counter value; comparing the candidate hash value to the public value; and enabling debugging based on the compared candidate hash value to the public value.

As another example, a non-transitory computer-readable medium having stored thereon instructions is provided. The instructions, when executed by at least one processor, cause the at least one processor to: receive a challenge message in response to a request to enable debugging from a target device, wherein the challenge message includes a public value of the target device, and a current replay counter value of the target device; hash a secret value a first number of times to obtain an intermediate hash value, wherein the first number of times is based on the current replay counter value and a maximum value of a replay counter; and transmit, in response to the challenge message, a challenge response including the intermediate hash value.

In another example, an apparatus for debugging is provided. The apparatus includes: means for transmitting a challenge message, the challenge message including a public value of a device and a current replay counter value of the device; means for receiving, in response to the challenge message, an intermediate hash value; hashing the intermediate hash value a first number of times to obtain a candidate hash value, wherein the first number of times is based on the current replay counter value; means for comparing the candidate hash value to the public value; and means for enabling debugging based on the compared candidate hash value to the public value.

In some aspects, one or more of the apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) includes at least one camera for capturing one or more images or video frames. For example, the apparatus(es) can include a camera (e.g., an RGB camera) or multiple cameras for capturing one or more images and/or one or more videos including video frames. In some aspects, the apparatus(es) includes at least one display for displaying one or more images, videos, notifications, or other displayable data. In some aspects, the apparatus(es) includes at least one transmitter configured to transmit one or more video frame and/or syntax data over a transmission medium to at least one device. In some aspects, the at least one processor includes a neural processing unit (NPU), a neural signal processor (NSP), a central processing unit (CPU), a graphics processing unit (GPU), any combination thereof, and/or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 illustrates an example of a system for debug re-enablement, in accordance with aspects of the present disclosure;

FIG. 2 is a block diagram illustrating debug re-enablement using hash chain-based message authentication, in accordance with aspects of the present disclosure;

FIG. 3 illustrates an example hash chain including a bit array, in accordance with aspects of the present disclosure;

FIG. 4 illustrates a Merkle tree for storing a set of public values for a target device, in accordance with aspects of the present disclosure;

FIG. 5 illustrates a Merkle tree illustrating another example of storing a set of values for a target device, in accordance with aspects of the present disclosure;

FIG. 6 is a flow diagram illustrating a process for debugging, in accordance with aspects of the present disclosure;

FIG. 7 is a flow diagram illustrating a process for debugging, in accordance with aspects of the present disclosure; and

FIG. 8 is a diagram illustrating an example of a system for implementing certain aspects of the present technology.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of subject matter of the application. However, it will be apparent that various examples may be practiced without these specific details. The figures and description are not intended to be restrictive.

The ensuing description provides illustrative examples only, and is not intended to limit the scope, applicability, or configuration of the disclosure. Rather, the ensuing description will provide those skilled in the art with an enabling description for implementing the illustrative examples. It should be understood that various changes may be made in the function and arrangement of elements without departing from the spirit and scope of the application as set forth in the appended claims.

After a chip (e.g., SoC, processor, or other component capable of processing information) is produced the chip may be in a normal or user mode under which the chip may be used in a normal manner by a user. In some cases, the chip may encounter an issue and may be returned. To help improve quality, the chip may be debugged to help determine what may have caused the issue and/or to fix the issue. It may be useful to enable a debugging mode on the chip to assist debugging. The debugging mode may enable features and/or operations that may allow some protections built into the chip to be circumvented, confidential information to be accessed, or otherwise allow the chip to operate in ways that are not permitted in normal use. For example, debugging mode may enable certain features or permit operations that are typically not permitted such as single stepping instructions, access to certain elements and/or portions of the chip that normally are not allowed, enhanced permissions, and the like. To prevent unauthorized access to the debugging mode, access to the debugging mode may be secured. As an example, access to debugging features may be secured using digital signatures, such as a digital signature using an elliptic curve digital signature algorithm (ECDSA), or embedded symmetric keys. For relatively low powered chips, such as small battery-operated devices, internet-of-things devices, sensing devices, etc., digital logic sufficient to verify digital signatures may take up a substantial amount of silicon area as compared to the rest of the chip. Additionally, certain low-powered chips may not utilize functionality enabled by such digital logic sufficient to verify digital signatures and thus the silicon area used to enable such functionality would only be used to enable re-enablement of a debugging mode. Further embedded symmetric keys may be a security concerns with the presence of hardware hackers. Thus, improved techniques for debug re-enablement may be useful.

Systems, apparatuses, electronic devices, methods (also referred to as processes), and computer-readable media (collectively referred to herein as “systems and techniques”) are described herein are techniques for enabling debugging using a hash chain-based message authentication. For example, it may be useful to reenable debugging on a chip that has been manufactured for use to investigate (e.g., debug) an issue. For example, a target device to be debugged may be connected to a debugging device. The debugging device may be a device that communicates with the target device to place the target device in a debug mode (e.g., debugging mode). The debug mode may allow access to features (e.g., debugging features) that may allow some protections built into the chip to be circumvented, confidential information to be accessed, or otherwise allow the chip to operate in ways that are not permitted in normal use (e.g., in a normal or user mode) and therefore access to the debug mode may be secured using an authorization or authentication technique.

As a part of such a technique, a target device may be provisioned with certain information as a part of manufacturing the target device. For example, the target device may be provisioned with an identifier, such as a serial number, along with a public value (X). The public value X may be a number derived from a secret number (e.g., a secret key) that is stored on the target device. The target device may also have a replay counter, which may be a counter that tracks a number of times the target device has been placed in debug mode. The replay counter may have a maximum value.

The public value X may be determined, for example, by the debugging device (or another device associated with the debugging device) based on a secret key and the identifier of the target device. For example, the secret key and identifier may be hashed to generate a secret value for the apparatus. This secret value may not be stored on the target device. This secret value may then be hashed a number of times to obtain the public value X, where the number of times the secret value is hashed is based on the maximum value of the replay counter. Hashing a value a number of times may be performed by hashing a value and then taking an output of the hash and hashing the output. Thus, the public value may be a value obtained after hashing the secret value a number of times. This process is repeated multiple times to generate a hash chain with a final output, here, the public value X. In some cases, the secret key may be a per product line random value.

To enable the debug mode, the debugging device may transmit a request to connect to the target device and/or a request for the target device to enter the debug mode. The target device may transmit a challenge message to the debugging device. The challenge message may be a message provided by the target device which, implicitly or explicitly, requests that the debugging device respond with a valid response. The valid response may be an intermediate hash value determined based on the replay counter. The challenge message may include the public value X of the target device and a current value of the replay counter (e.g., current replay counter value). The debugging device may receive the challenge message and the debugging device may hash the secret value a number of times to obtain an intermediate hash value. The number of times the secret value is hash may be based on the current replay counter value and the maximum value of the replay counter. For example, t number of times the secret value is hashed may be the difference between the maximum value of the replay counter and the current replay counter value. The intermediate hash value may be a value that is produced as a part of a hash chain, but is not the final output. Rather, the intermediate hash value may be hashed again as a part of the hash chain. The intermediate hash value may be transmitted to the target device as a part of a challenge response (e.g., a response to the challenge message).

The target device may receive the challenge response including the intermediate hash. The target device may hash the intermediate hash value a number of times to obtain a candidate hash value. The candidate hash value may be a value of the hash chain to be compared with an expected value. The number of times to hash the intermediate hash value may be based on the current replay counter value. In some cases, the number of times the secret value is hashed to generate the intermediate hash value and the number of times the intermediate hash value is hashed may equal maximum value of the replay counter (plus one). The candidate hash value may then be compared to the public value of the target device. If the candidate hash value equals the public value, then the target device may enable debugging.

Various aspects of the application will be described with respect to the figures.

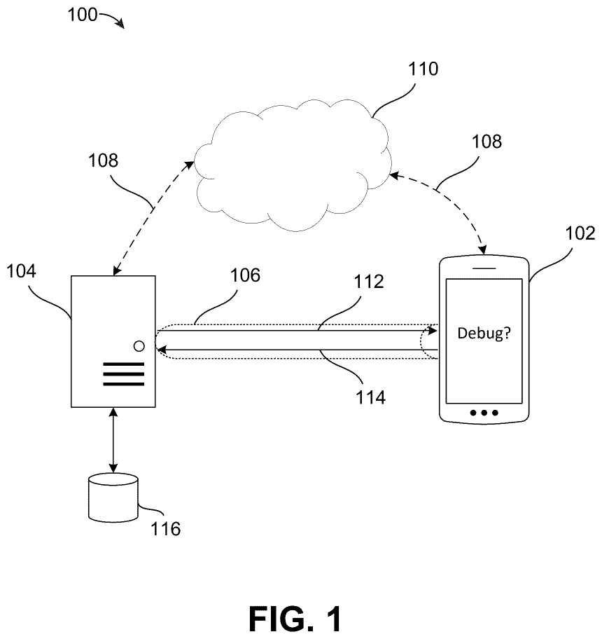

FIG. 1 illustrates an example of a system 100 for debug re-enablement, in accordance with aspects of the present disclosure. The system 100 includes a target device 102 for debugging, and a debugging device 104. In some cases, the target device 102 may include a component, such as a chip, SoC, processor, add-in card, peripheral, etc., that is being debugged and the target device 102 may be a mobile device, personal digital assistant (PDA), email device, pager, a notebook computer, wired device, desktop computer, workstation, IoT device, sensor, etc. The debugging device 104 may be any device or set of devices (e.g., mobile device, PDA, tablet, a notebook computer, wired device, desktop computer, workstation, server devices, any combination thereof, etc.) capable of generating and/or transmitting a message to the target device 102 to enable a debug mode of the target device 102. In some cases, the debugging device 104 may be coupled to the target device 102 via any wired connection 106, wireless connection 108, cloud connection 110 (e.g., internet), or any combination thereof. In some cases, the target device 102 may be directly connected to the debugging device 104.

To enable (e.g., reenable) a debugging mode of the target device 102, the debugging device 104 may send a request 112 to enable the debugging mode of the target device 102. In some cases, the request may include an authorization code indicating to the target device 102 that the debugging device 104 is authorized to access the debug mode, such as a digital signature, a symmetric key, or another authorization code. In some cases, the authorization code may be sent in response to a challenge message from the target device 102.

In some cases, the debugging device 104 may retrieve the authorization code from a database, such as database 116. The database 116 may be store authorization codes for target devices. For example, when the target device 102 is manufactured, the authorization code associated with the target device 102 in the database 116.

The target device 102 may authenticate the received authorization code. If the authorization code is authenticated, the target device 102 may enter the debug mode. The target device 102 may also send 114 an indication that the target device 102 has entered the debug mode back to the debugging device 104. In some cases, the debugging device 104 may then access the target device 102 using one or more operations and/or command available in the debugging mode to debug the target device 102.

As indicated above, embedding a symmetric key on the target device 102 can be problematic from a security standpoint, and it may not be feasible to equip low powered devices to verify ECDSA based digital signatures to use for debug enablement. In some cases, hashing may be used for debug enablement. Hashing may use a one-way function that is substantially less computationally complex to implement as compared to ECDSA based digital signatures and this one-way function may transform input data into a fixed size output data. In some cases, hashing may be chained by hashing input data to generate first output data. This first output data may be input to the same hashing function as input data to generate second output data. This process may be repeated as many times as defined by a number of chains in the hash chain.

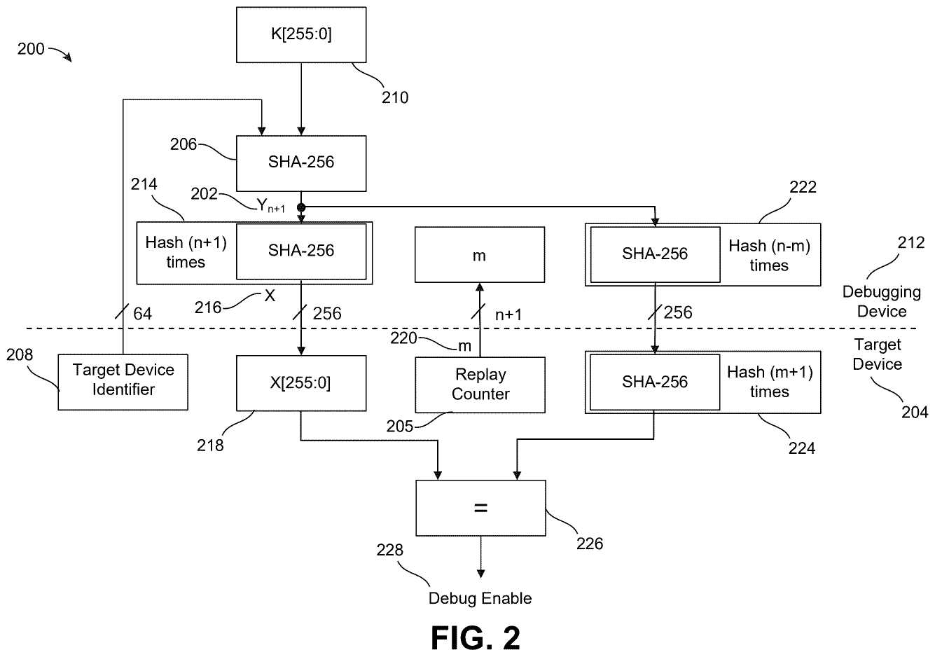

FIG. 2 is a block diagram illustrating debug re-enablement using hash chain-based message authentication 200, in accordance with aspects of the present disclosure. In some cases, a secret value 202 (Yₙ₊₁) (e.g., private value) may be associated with a target device 204. In some cases, n may be a maximum value of a replay counter 205 of the target device 204. The maximum value of the replay counter 205 may represent a maximum number of times debug mode may be enabled on the target device 204. The maximum value of the replay counter 205 may be known to the debugging device 212. The secret value 202 (Yₙ₊₁) may be a derived value. For example, the secret value 202 (Yₙ₊₁) may be a derived based on a hash 206 of a secret key 210 (K) and an identifier 208 of the target device 204 (e.g., target device identifier). In some cases, the target device identifier 208 may be a serial number, globally unique identifier, or any other identifier of the target device 204 and the target device identifier 208 may be assigned as a part of manufacturing the target device 204. The secret key 210 (K) may be securely stored on a debugging device 212 or other device accessible to the debugging device 212.

The secret value 202 (Yₙ₊₁) may be hashed a number of times, where the number of times is based on the maximum value of the replay counter 205. For example, the secret value 202 (Yₙ₊₁) may be hashed n+1 times 214 to generate a public value 216 (X). In some cases, a value of each hash (e.g., of the n+1 hashes) may be stored by the debugging device 212. The public value 216 (X) may be transferred to the target device 204 and stored by the target device 204. In some cases, the public value 216 (X) may be sent to the target device 204 as a part of manufacturing the target device 204, such as during a provisioning stage. The public value 216 (X) may be stored as a stored public value 218 (X) in a non-volatile memory of the target device 204, such as in a set of eFuses. In some cases, an eFuse operates such that current will flow through an unblown eFuse, but the current will not flow through a blown eFuse (e.g., because the conductor material in the eFuse has failed). Such operation allows a single eFuse to store 1 bit of information (e.g., a 1 or a 0). Blowing an eFuse is a one-time operation as, once blown, an eFuse cannot be unblown. In some cases, the target device identifier 208 and replay counter 205 may also be stored in sets of eFuses. As the public value 216 (X) is a result of a chain of hashes, the public value 216 (X) does not reveal the secret value 202 (Yₙ₊₁). Of note, while the hashing shown in FIG. 2 are illustrated as being performed using secure hash algorithm 256 (SHA-256), it should be understood that any hashing algorithm that is preimage resistant may be used to perform the hashing. A preimage resistant hashing algorithm may be a hashing algorithm for which it is computationally difficult to identify an input that that hashes to a particular value (e.g., the public value 216). In some cases, a hash key derivation function (HKDF) may be used. In some cases, generating and storing the stored public value 218 (X) on the target device 204 may be performed by a device separate from the debugging device 212.

To enable debugging on the target device 204, the target device 204 may present the stored public value 218 (X) and a current replay counter value 220 (m) to the debugging device 212 as a part of a challenge message. The debugging device 212 may obtain the secret value 202 (Yₙ₊₁). For example, the debugging device 212 may determine the secret value 202 (Yₙ₊₁) based on the secret key 210 (K) and target device identifier 208. The debugging device 212 may hash the obtained secret value 202 (Yₙ₊₁) a number of times, such as n-m times 222, to generate an intermediate hash (e.g., hashed n-m times 222) (e.g., preimage hash value) of the hash chain (e.g., where the secret value 202 (Yₙ₊₁) was hashed n+1 times 214). In cases where a value of each hash (e.g., of the n+1 hashes) of the hash chain was stored, the debugging device 212 may look up the intermediate hash based on the current replay counter value 220 (m) received from the target device 204. The debugging device 212 may generate a challenge response (e.g., authorization code) including the intermediate hash and transmit the challenge response to the target device.

The target device 204 may obtain the intermediate hash from the challenge response and the target device 204 may hash the intermediate hash a number of times based on the current replay counter value 220 (m). For example, the target device 204 may hash the intermediate hash value m+1 times 224 to obtain a candidate hash value. As the intermediate hash was previously hashed n-m times 222 by the debugging device 212, hashing the intermediate hash m+1 times 224 by the target device 204 results in the secret value 202 (Yₙ₊₁) being hashed a total of n+1 times, which should be equal to the stored public value 218 (X). The candidate hash value may be compared to the stored public value 218 (X). If the candidate hash value is equal 226 to the stored public value 218 (X), the target device 204 may enable the debugging mode 228. If the candidate hash value is not equal to the stored public value 218 (X), the target device 204 may not enable the debugging mode.

In some cases, replay protection may be used. For replay protection, the target device 204 may burn (e.g., irreversibly destroy) a counter value when debugging is enabled to increment (or decrement for a countdown counter) the replay counter 205. This burned counter effectively increments m by one. This may change the number of times the debugging device may hash to obtain the intermediate hash value and the number of times the target device may hash the intermediate hash value to obtain the candidate hash value.

In some cases, it may be useful to enable more granular debug modes rather than a binary access to debug mode. For example, a more granular debug mode may be used to allow access to specific debug features while not allowing access to other debug features. To enable more granular debug modes, the hash chain-based message authentication 200 may be modified to include an indication of debug features (e.g., features, settings, access, etc.) to enable/disable. This indication of debug features to enable/disable may be a bit array (e.g., bit vector) (M) where values of the bit array correspond to features to enable/disable. This bit array (M) may be included in the hash chain.

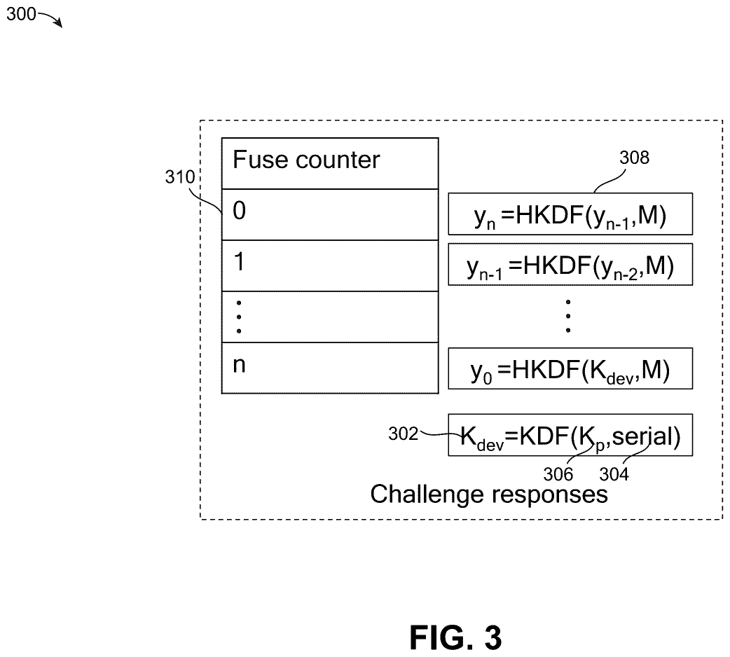

FIG. 3 illustrates an example hash chain including a bit array 300, in accordance with aspects of the present disclosure. In a manner similar to that discussed above, a secret value 302 (K_{dev}) (e.g., where K_{dev} is equivalent to Yₙ₊₁ of FIG. 2) may be derived using a key derivation function (KDF), hash function, or hash KDF (hereinafter HKDF) based on an identifier 304 of a target device and a secret key (Kₚ) 306 (e.g., where Kₚ is equivalent to K of FIG. 2). In some cases, the secret key (Kₚ) 306 may be a product line specific secret key. The secret value 302 (K_{dev}) and a bit array M may be put through a HKDF chain n+1 times to generate a public value (yₙ) (e.g., preimage hash value), where n may be a maximum value of a replay counter of the target device. A set of public values may be generated for a set of bit arrays available.

The bit array M may indicate the debug features to enable/disable. In some cases, all possible variations of M may be known in advance. For example, while there may be a large number of possible variations of M (e.g., over 18 quintillion possible variations for a 64 bit array), in practice only a relatively small number of variations of M may be needed, such as for different possible debugging entities (e.g., vendor, developer, OEM, etc.). A set of bit arrays may then be defined, where each bit array M of the set of bit arrays includes a different set of debug features to enable/disable. Each bit array M of the set of bit arrays may be used to determine a separate public value X using a HKDF function based on M and the secret value (yₙ), such that X=HKDF(y₀, M), y₀=HKDF(y₁, M) . . . yₙ=HKDF(yₙ₊₁, M) to generate the set of public values. The bit array may be repeated for each round, and output from a previous round may be input as a key for a next round. This set of public values may be stored on the target device. In some cases, the set of public values may be stored in an eFuse array.

To enable debugging on the target device, the target device may present the current replay counter value (m), along with a set of public values. The debugging device may request enabling a particular set of debug features as defined in bit array M by determining the secret value 302 (K_{dev}), apply the HKDF to the secret value 302 (K_{dev}) and M, n−1 times to obtain intermediate hash value (yₙ) 308 (at fuse counter 0 310). The intermediate hash value (yₙ) 308 may be sent along with the bit array M to by the debugging device in a challenge response to the target device.

The target device may apply the HKDF function to the intermediate hash value (yₙ) 308 and bit array M to obtain a candidate hash value. The target device may then compare the candidate hash values with the stored set of public values to determine is a public value X matches the candidate value. If there is a match, then the target device may enable the debugging mode based on the bit array M. If there is not a match, then the target device may not enable the debugging mode.

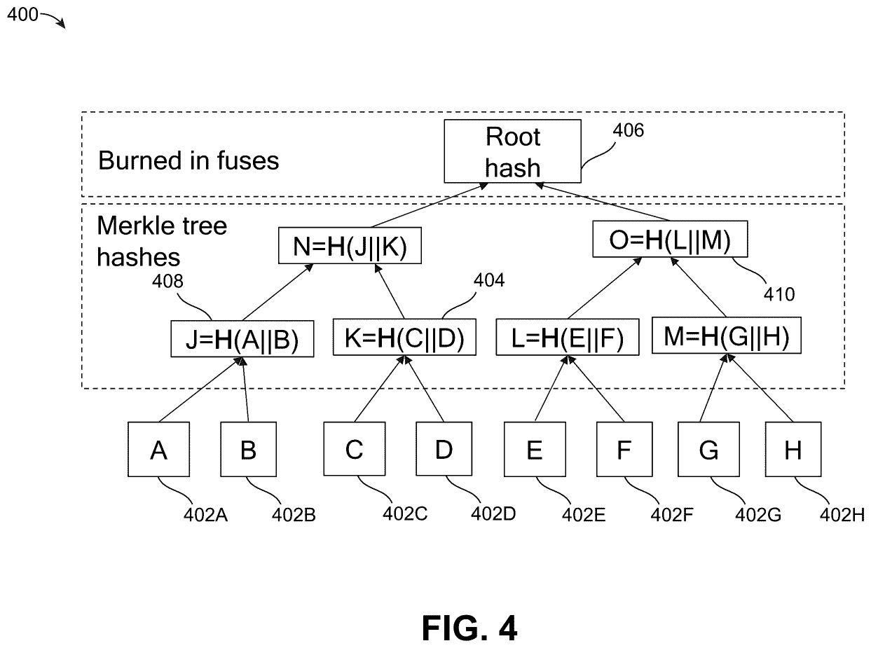

In some cases, rather than storing a full set of public values on the target device, a Merkle tree may be used to describe the full set of public values. FIG. 4 illustrates a Merkle tree 400 for storing a set of public values for a target device, in accordance with aspects of the present disclosure. In FIG. 4, leaf nodes 402A, 402B, 402C, 402D, 402E, 402F 402G, and 402H (collectively referred to herein as leaf nodes 402) may represent the set of public values (a set of X values) for a set of valid bit arrays for the target device as described above with respect to FIG. 3. For example, with reference to FIG. 3, each bit array M of the set of bit arrays may be used to determine a separate public value X using a HKDF function based on M and the intermediate hash value (yₙ), such that X=HKDF(yₙ, M) to generate a set of public values and the public values (M) may be represented by the leaf nodes 402.

In a Merkel tree, each non-leaf node, such a node K 404, may include a value of a hash of the nodes or leaves under it. Thus, node K 404 may include a hash value based on the public values (Ms) corresponding to leaf C 402C and leaf D 402D. In some cases, the debugging device may precalculate all (or calculate as needed) of the values of the Merkle tree 400. The value of a root node 406 may be stored on the target device. In some cases, the value of the root node 406 (e.g., root hash value) may be stored in a set of eFuses of the target device. The set of public values may be omitted from the target device.

To enable debugging on the target device, the target device may present the current replay counter value (m) as discussed above. The debugging device may request enabling a particular set of debug features as defined in bit array M by obtaining an intermediate hash value (yₙ) in a manner substantially similar to that described above with respect to FIG. 3. As an example, if the intermediate hash value (yₙ) corresponds (e.g., is a preimage of) to a public value (X) of leaf C 402C, the debugging device may provide the intermediate hash value (yₙ), bit array M, and a Merkle proof to the target device. The Merkle proof may be a set of hashes proving a membership of the leaf C 402C in the Merkle tree 400. In this example, the Merkle proof may include a value of leaf D 402D, a value of node J 408, and a value of node O 410.

The target device may then verify the debugging device by determining a candidate hash value in a manner substantially similar to that described above with respect to FIG. 3. This candidate hash value should be equal to the public value of leaf C 402C. The target device may then compute a set of hash values based on the candidate hash value and the values in the Merkle proof to obtain a candidate Merkle value. This candidate Merkle value should be equal to the root hash value of the root node 406. If there is a match, then the target device may enable the debugging mode based on the bit array M. If there is not a match, then the target device may not enable the debugging mode.

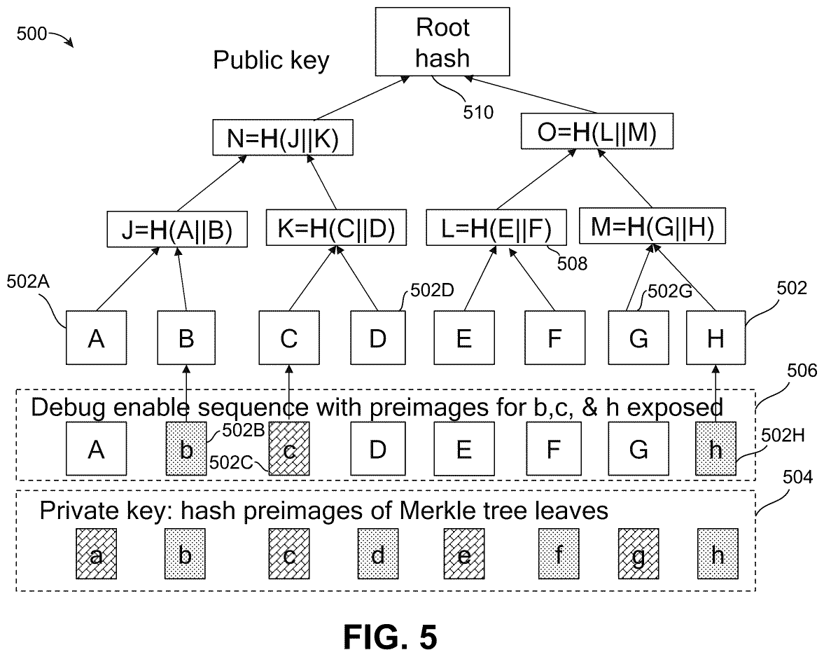

FIG. 5 illustrates a Merkle tree 500 illustrating another example of storing a set of values for a target device, in accordance with aspects of the present disclosure. The Merkle tree 500 may be similar to Merkle tree 400 except that the leaves 502 of the Merkle tree 500 may be based on portions of the bit array M such that each leaf of the leaves 502 may represent different debug features to enable/disable. In some cases, a KDF expansion (or extendable output function (XOF)) may be applied to a portion of the bit array M. In some cases, the KDF expansion/XOF may be based on a secret key (e.g., seed). Each portion of the bit array M may be assigned to a particular leaf of the leaves. A value for a leaf, such as leaf 502H, may be determined in a manner similar to how a public value X may be determined for a leaf in FIG. 4 (e.g., via a hash chain of n depth) to generate a set of preimage hash values 504 for the leaves 502.

To enable debugging on the target device, the debugging device may determine a debug enable sequence 506 for the specific features to be enabled, such as those corresponding to leaves 502B, 502C, and 502H. The debugging device may determine intermediate hash values for each of the portions of the debug enable sequence for leaves 502B, 502C, and 502H in a manner substantially similar to that discussed above with respect to FIGS. 3 and 4. The debugging device may provide the intermediate hash values and a Merkle proof for each of leaves 502A, 502C, and 502H to the target device (e.g., values for leaf 502A, leaf 502D, leaf 502G, and node L 508).

The target device may then verify the debugging device by determining candidate hash values for each leaf of the debug enable sequence (e.g., leaves 502B, 502C, and 502H) in a manner substantially similar to that described above with respect to FIG. 3 and the candidate hash values should be equal to the values for leaves 502B, 502C, and 502H. The target device may then compute a set of hash values based on the candidate hash values and the values in the Merkle proof to obtain a candidate Merkle value. This candidate Merkle value should be equal to the root hash value of the root node 510. If there is a match, then the target device may enable the debugging mode based on the features associated with leaves 502B, 502C, and 502H. If there is not a match, then the target device may not enable the debugging mode.

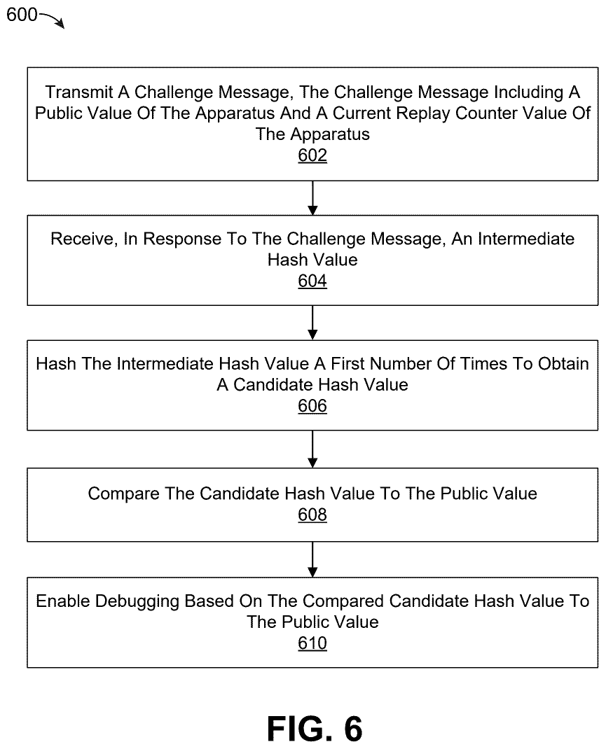

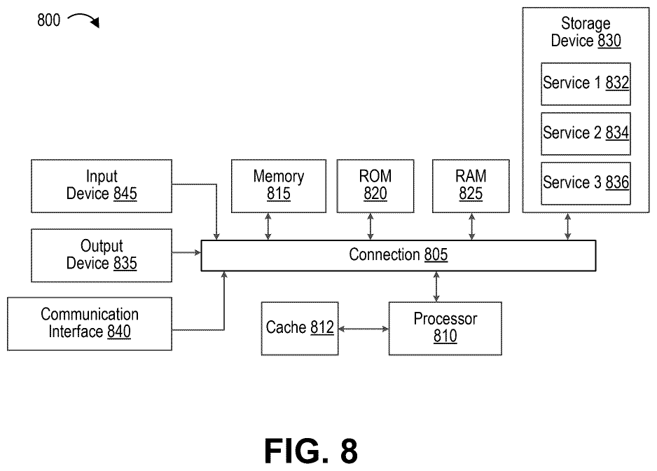

FIG. 6 is a flow diagram illustrating a process 600 for debugging, in accordance with aspects of the present disclosure. The process 600 may be performed by a computing device (e.g., apparatus, target device 102 of FIG. 1, target device 204 of FIG. 2, computing system 800, etc.) or a component (e.g., a chipset, codec, etc., such as a processor 810 of FIG. 8) of the computing device. The computing device may be a mobile device (e.g., a mobile phone), a network-connected wearable such as a watch, an extended reality (XR) device such as a virtual reality (VR) device or augmented reality (AR) device, a laptop computer, desktop computer, tablet, vehicle or component or system of a vehicle, or other type of computing device. The operations of the process 600 may be implemented as software components that are executed and run on one or more processors (e.g., processor 810 of FIG. 8, and/or other processor(s)). In some cases, the operations of the process 600 can be implemented by a system having the architecture of computing system 800 of FIG. 8.

At block 602, the computing device (or component thereof) may transmit a challenge message. The challenge message includes a public value (e.g., public value 218 of FIG. 2) of the computing device and a current replay counter value (e.g., current replay counter value 220 (m) of FIG. 2) of the computing device. In some cases, the public value of the computing device is based on a secret value (e.g., secret value 202 of FIG. 2, secret value 302 of FIG. 3) hashed a second number of times. The second number of times is based on a maximum value (e.g., maximum value n of the replay counter 205 of FIG. 2) of a replay counter (e.g., replay counter 205 of FIG. 2). In some examples, the secret value is determined based on an identifier (e.g., identifier 208 of FIG. 2, identifier 304 of FIG. 3) of the apparatus. In some cases, the public value of the computing device is received as a part of provisioning the computing device.

At block 604, the computing device (or component thereof) may receive, in response to the challenge message, an intermediate hash value (e.g., intermediate hash value 308 of FIG. 3). In some cases, the challenge message includes a set of public values. In some examples, the set of public values are represented by a Merkle tree (e.g., Merkle tree 400 of FIG. 4, Merkle tree 500 of FIG. 5). In some examples, the computing device (or component thereof) may obtain a bit array. The intermediate hash value is hashed with the bit array the first number of times to obtain the candidate hash value. The computing device (or component thereof) may enable one or more debugging features based on the obtained bit array. For example, target device may apply the HKDF function to the intermediate hash value (yₙ) 308 and bit array M to obtain a candidate hash value and compare the candidate hash values with the stored set of public values to determine is a public value X matches the candidate value. If there is a match, then the target device may enable the debugging mode based on the bit array M.

At block 606 the computing device (or component thereof) may hash the intermediate hash value a first number of times (e.g., hash the intermediate hash value m+1 times 224 of FIG. 2) to obtain a candidate hash value. In some cases, the first number of times is based on the current replay counter value (e.g., current replay counter value 220 (m) of FIG. 2).

At block 608, the computing device (or component thereof) may compare the candidate hash value to the public value (e.g., check to see if they are equal 226 of FIG. 2).

At block 610, the computing device (or component thereof) may enable debugging based on the compared candidate hash value to the public value. In some cases, the computing device (or component thereof) may increment the replay counter based on enabling debugging.

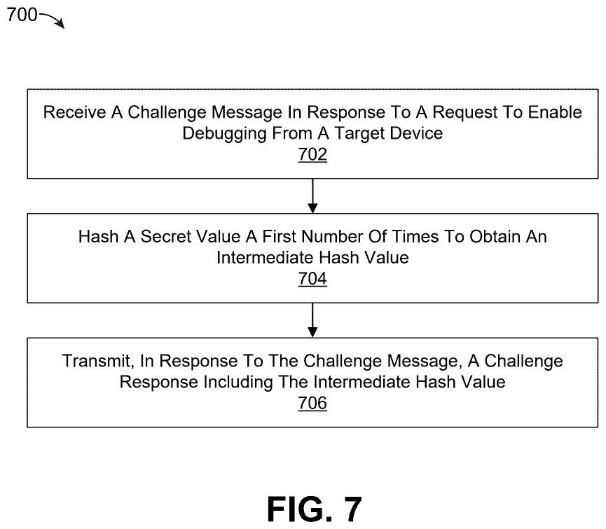

FIG. 7 is a flow diagram illustrating a process 700 for debugging, in accordance with aspects of the present disclosure. The process 700 may be performed by a computing device (e.g., apparatus, debugging device 104 of FIG. 1, debugging device 212 of FIG. 2, computing system 800, etc.) or a component (e.g., a chipset, codec, etc., such as a processor 810 of FIG. 8) of the computing device. The computing device may be a mobile device (e.g., a mobile phone), a network-connected wearable such as a watch, an extended reality (XR) device such as a virtual reality (VR) device or augmented reality (AR) device, a laptop computer, desktop computer, tablet, vehicle or component or system of a vehicle, or other type of computing device. The operations of the process 700 may be implemented as software components that are executed and run on one or more processors (e.g., processor 810 of FIG. 8, and/or other processor(s)). In some cases, the operations of the process 700 can be implemented by a system having the architecture of computing system 800 of FIG. 8.

At block 702, the computing device (or component thereof) may receive a challenge message in response to a request to enable debugging from a target device (e.g., target device 204 of FIG. 2). In some cases, the challenge message includes a public value (e.g., public value 218 of FIG. 2) of the target device, and a current replay counter value (e.g., current replay counter value 220 (m) of FIG. 2) of the target device. In some examples, the computing device (or component thereof) may generate the public value of the target device by hashing a secret value e.g., secret value 202 of FIG. 2, secret value 302 of FIG. 3) a second number of times. The second number of times is based on a maximum value (e.g., maximum value n of the replay counter 205 of FIG. 2) of the replay counter. In some cases, the computing device (or component thereof) may provide the public value to the target device as a part of provisioning the target device.

At block 704, the computing device (or component thereof) may hash a secret value (e.g., secret value 202 of FIG. 2, secret value 302 of FIG. 3) a first number of times to obtain an intermediate hash value (e.g., intermediate hash value 308 of FIG. 3). In some cases, the first number of times is based on the current replay counter value and a maximum value (e.g., maximum value n of the replay counter 205 of FIG. 2) of a replay counter (e.g., replay counter 205 of FIG. 2). In some examples, the secret value is determined based on an identifier (e.g., identifier 208 of FIG. 2, identifier 304 of FIG. 3) of the computing device. In some cases, the challenge message includes a set of public values. In some examples, set of public values are represented by a Merkle tree (e.g., Merkle tree 400 of FIG. 4, Merkle tree 500 of FIG. 5). In some cases, the secret value is hashed with a bit array the first number of times to obtain the intermediate hash value. In some examples, the bit array indicates one or more debugging features of the target device. In some cases, the computing device (or component thereof) may transmit the bit array to the target device. In some examples, the set of public values are represented by leaves of the Merkle tree (e.g., leaf nodes 402 of FIG. 4, leaves 502 of FIG. 2).

At block 706, the computing device (or component thereof) may transmit, in response to the challenge message, a challenge response including the intermediate hash value. In some cases, the computing device (or component thereof) may transmit a Merkle proof to the target device.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 600, process 700, and/or other processes described herein may include a processor, microprocessor, micro-computer, or other component of a device that is configured to carry out the steps of the process 600, process 700, and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 600, process 700, and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 600 and process 700 are illustrated as logical flow diagrams, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 600, process 700, and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 is a diagram illustrating an example of a system for implementing certain aspects of the present technology. In particular, FIG. 8 illustrates an example of computing system 800, which can be for example any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some examples, computing system 800 is a distributed system in which the functions described in this disclosure can be distributed within a datacenter, multiple data centers, a peer network, etc. In some examples, one or more of the described system components represents many such components each performing some or all of the functions for which the component is described. In some cases, the components can be physical or virtual devices.

Example computing system 800 includes at least one processing unit (CPU or processor) 810 and connection 805 that couples various system components including system memory 815, such as read-only memory (ROM) 820 and random access memory (RAM) 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, camera, accelerometers, gyroscopes, etc. Computing system 800 can also include output device 835, which can be one or more of a number of output mechanisms. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission of wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.10 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some examples, a hardware service that performs a particular function can include the software component stored in a computer-readable medium in connection with the necessary hardware components, such as processor 810, connection 805, output device 835, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples provided herein. However, it will be understood by one of ordinary skill in the art that the examples may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination oThe, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the present disclosure include:
Aspect 1. An apparatus for debugging, the apparatus comprising: at least one memory; and at least one processor coupled to the at least one memory, the at least one processor being configured to: transmit a challenge message, the challenge message including a public value of the apparatus and a current replay counter value of the apparatus; receive, in response to the challenge message, an intermediate hash value; hash the intermediate hash value a first number of times to obtain a candidate hash value, wherein the first number of times is based on the current replay counter value; compare the candidate hash value to the public value; and enable debugging based on the compared candidate hash value to the public value.
Aspect 2. The apparatus of Aspect 1, wherein the public value of the apparatus is based on a secret value hashed a second number of times, wherein the second number of times is based on a maximum value of a replay counter.
Aspect 3. The apparatus of Aspect 2, wherein the public value of the apparatus is received as a part of provisioning the apparatus.
Aspect 4. The apparatus of any of Aspects 2-3, wherein the at least one processor is configured to increment the replay counter based on enabling debugging.
Aspect 5. The apparatus of any of Aspects 2-4, wherein the secret value is determined based on an identifier of the apparatus.
Aspect 6. The apparatus of any of Aspects 1-5, wherein the challenge message includes a set of public values, and wherein the at least one processor is configured to: obtain a bit array, wherein the intermediate hash value is hashed with the bit array the first number of times to obtain the candidate hash value; and enable one or more debugging features based on the obtained bit array.
Aspect 7. The apparatus of Aspect 6, wherein the set of public values are represented by a Merkle tree.
Aspect 8. An apparatus for debugging, the apparatus comprising: at least one memory; and at least one processor coupled to the at least one memory, the at least one processor being configured to: receive a challenge message in response to a request to enable debugging from a target device, wherein the challenge message includes a public value of the target device, and a current replay counter value of the target device; hash a secret value a first number of times to obtain an intermediate hash value, wherein the first number of times is based on the current replay counter value and a maximum value of a replay counter; and transmit, in response to the challenge message, a challenge response including the intermediate hash value.
Aspect 9. The apparatus of Aspect 8, wherein the at least one processor is configured to generate the public value of the target device by hashing the secret value a second number of times, wherein the second number of times is based on a maximum value of the replay counter.
Aspect 10. The apparatus of Aspect 9, wherein the at least one processor is configured to provide the public value to the target device as a part of provisioning the target device.
Aspect 11. The apparatus of any of Aspects 8-10, wherein the secret value is determined based on an identifier of the apparatus.
Aspect 12. The apparatus of any of Aspects 8-11, wherein the challenge message includes a set of public values, wherein the secret value is hashed with a bit array the first number of times to obtain the intermediate hash value, wherein the bit array indicates one or more debugging features of the target device; and wherein the at least one processor is configured to transmit the bit array to the target device.
Aspect 13. The apparatus of Aspect 12, wherein the set of public values are represented by a Merkle tree.
Aspect 14. The apparatus of Aspect 13, wherein the set of public values are represented by leaves of the Merkle tree, and wherein the at least one processor is configured to transmit a Merkle proof to the target device.
Aspect 15. A method for debugging, comprising: transmitting a challenge message, the challenge message including a public value of a device and a current replay counter value of the device; receiving, in response to the challenge message, an intermediate hash value; hashing the intermediate hash value a first number of times to obtain a candidate hash value, wherein the first number of times is based on the current replay counter value; comparing the candidate hash value to the public value; and enabling debugging based on the compared candidate hash value to the public value.
Aspect 16. The method of Aspect 15, wherein the public value of the device is based on a secret value hashed a second number of times, wherein the second number of times is based on a maximum value of a replay counter.
Aspect 17. The method of Aspect 16, wherein the public value of the device is received as a part of provisioning the device.
Aspect 18. The method of any of Aspects 16-17, further comprising incrementing the replay counter based on enabling debugging.
Aspect 19. The method of any of Aspects 16-18, wherein the secret value is determined based on an identifier of the device.
Aspect 20. The method of any of Aspects 15-19, wherein the challenge message includes a set of public values, and further comprising: obtain a bit array, wherein the intermediate hash value is hashed with the bit array the first number of times to obtain the candidate hash value; and enable one or more debugging features based on the obtained bit array.
Aspect 21. The method of Aspect 20, wherein the set of public values are represented by a Merkle tree.
Aspect 22. A method for debugging, comprising: receiving a challenge message in response to a request to enable debugging from a target device, wherein the challenge message includes a public value of the target device, and a current replay counter value of the target device; hashing a secret value a first number of times to obtain an intermediate hash value, wherein the first number of times is based on the current replay counter value and a maximum value of a replay counter; and transmitting, in response to the challenge message, a challenge response including the intermediate hash value.
Aspect 23. The method of Aspect 22, further comprising generating the public value of the target device by hashing the secret value a second number of times, wherein the second number of times is based on a maximum value of the replay counter.
Aspect 24. The method of Aspect 23, further comprising providing the public value to the target device as a part of provisioning the target device.
Aspect 25. The method of any of Aspects 22-24, wherein the secret value is determined based on an identifier of a device.
Aspect 26. The method of any of Aspects 22-25, wherein the challenge message includes a set of public values, wherein the secret value is hashed with a bit array the first number of times to obtain the intermediate hash value, wherein the bit array indicates one or more debugging features of the target device; and further comprising transmitting the bit array to the target device.
Aspect 27. The method of Aspect 26, wherein the set of public values are represented by a Merkle tree.
Aspect 28. The method of Aspect 27, wherein the set of public values are represented by leaves of the Merkle tree, and further comprising transmitting a Merkle proof to the target device.
Aspect 29. A non-transitory computer-readable medium having stored thereon instructions that, when executed by at least one processor, cause the at least one processor to performing one or more of operations according to any of Aspects 17 to 28.

Aspect 30: An apparatus for debugging, comprising means for performing one or more of operations according to any of Aspects 17 to 28.

What is claimed is:

1. An apparatus for debugging, the apparatus comprising:
at least one memory; and
at least one processor coupled to the at least one memory, the at least one processor being configured to:
transmit a challenge message, the challenge message including a public value of the apparatus and a current replay counter value of the apparatus;
receive, in response to the challenge message, an intermediate hash value;
hash the intermediate hash value a first number of times to obtain a candidate hash value, wherein the first number of times is based on the current replay counter value;
compare the candidate hash value to the public value; and
enable debugging based on the compared candidate hash value to the public value.

2. The apparatus of claim 1, wherein the public value of the apparatus is based on a secret value hashed a second number of times, wherein the second number of times is based on a maximum value of a replay counter.

3. The apparatus of claim 2, wherein the public value of the apparatus is received as a part of provisioning the apparatus.

4. The apparatus of claim 2, wherein the at least one processor is configured to increment the replay counter based on enabling debugging.

5. The apparatus of claim 2, wherein the secret value is determined based on an identifier of the apparatus.

6. The apparatus of claim 1, wherein the challenge message includes a set of public values, and wherein the at least one processor is configured to:
obtain a bit array, wherein the intermediate hash value is hashed with the bit array the first number of times to obtain the candidate hash value; and
enable one or more debugging features based on the obtained bit array.

7. The apparatus of claim 6, wherein the set of public values are represented by a Merkle tree.

8. An apparatus for debugging, the apparatus comprising:
at least one memory; and
at least one processor coupled to the at least one memory, the at least one processor being configured to:
receive a challenge message in response to a request to enable debugging from a target device, wherein the challenge message includes a public value of the target device, and a current replay counter value of the target device;
hash a secret value a first number of times to obtain an intermediate hash value, wherein the first number of times is based on the current replay counter value and a maximum value of a replay counter; and
transmit, in response to the challenge message, a challenge response including the intermediate hash value.

9. The apparatus of claim 8, wherein the at least one processor is configured to generate the public value of the target device by hashing the secret value a second number of times, wherein the second number of times is based on a maximum value of the replay counter.

10. The apparatus of claim 9, wherein the at least one processor is configured to provide the public value to the target device as a part of provisioning the target device.

11. The apparatus of claim 8, wherein the secret value is determined based on an identifier of the apparatus.

12. The apparatus of claim 8, wherein the challenge message includes a set of public values, wherein the secret value is hashed with a bit array the first number of times to obtain the intermediate hash value, wherein the bit array indicates one or more debugging features of the target device, and wherein the at least one processor is configured to transmit the bit array to the target device.

13. The apparatus of claim 12, wherein the set of public values are represented by a Merkle tree.

14. The apparatus of claim 13, wherein the set of public values are represented by leaves of the Merkle tree, and wherein the at least one processor is configured to transmit a Merkle proof to the target device.

15. A method for debugging, comprising:
transmitting a challenge message, the challenge message including a public value of a device and a current replay counter value of the device;
receiving, in response to the challenge message, an intermediate hash value;
hashing the intermediate hash value a first number of times to obtain a candidate hash value, wherein the first number of times is based on the current replay counter value;
comparing the candidate hash value to the public value; and
enabling debugging based on the compared candidate hash value to the public value.

16. The method of claim 15, wherein the public value of the device is based on a secret value hashed a second number of times, wherein the second number of times is based on a maximum value of a replay counter.

17. The method of claim 16, wherein the public value of the device is received as a part of provisioning the device.

18. The method of claim 16, further comprising incrementing the replay counter based on enabling debugging.

19. The method of claim 16, wherein the secret value is determined based on an identifier of the device.

20. The method of claim 15, wherein the challenge message includes a set of public values, and further comprising:
obtain a bit array, wherein the intermediate hash value is hashed with the bit array the first number of times to obtain the candidate hash value; and
enable one or more debugging features based on the obtained bit array.
